(19) United States
(12) Patent Application Publication
(10) Pub. No.: US 2017/0356268 A1
(43) Pub. Date: Dec. 14, 2017

(54) Apparatus and Method for Sealing a Tubular Section

(71) Applicants: Roddie R. Smith, Katy, TX (US); Robert Joe Coon, Missouri City, TX (US)

(72) Inventors: Roddie R. Smith, Katy, TX (US); Robert Joe Coon, Missouri City, TX (US)

(21) Appl. No.: 15/614,686

(22) Filed: Jun. 6, 2017

Related U.S. Application Data
(60) Provisional application No. 62/397,041, filed on Sep. 20, 2016.
(60) Provisional application No. 62/349,177, filed on Jun. 13, 2016.

(51) Int. Cl. E21B 33/128; F16L 55/11; E21B 33/12; E21B 33/129

(52) U.S. Cl. CPC E21B 33/128; E21B 33/129; F16L 55/11; E21B 33/1208

(57) ABSTRACT

An apparatus for sealing a tubular section is provided. The apparatus may include a retainer and a dart. The retainer may include an annular body having a tapered outer surface and a slip having a left-hand thread profile defined in the slip. The slip may expand along the tapered outer surface of the annular body to hold the retainer in position within the tubular section. The dart may include a sealing element and a vented cap. The sealing element may include a body, a plurality of fins, and an engagement member that engages with a cavity of the vented cap. The cap may contact the annular body of the retainer. The sealing element may compress against the cap, sealing the tubular section.

### CROSS-REFERENCE TO RELATED APPLICATIONS

This application claims priority to U.S. Provisional Patent Application Ser. No. 62/349,177, filed on Jun. 13, 2016, and U.S. Provisional Patent Application Ser. No. 62/397,041, filed on Sep. 20, 2016. These applications are hereby incorporated by reference in their entirety into the present application to the extent consistent with the present application.

### BACKGROUND

In oil and gas production, it is sometimes beneficial to stimulate a reservoir by pumping in high pressure fluids and particulates, such as sand. In order to do this, portions of the well are isolated and then re-opened so the well can be produced. Some current isolation methods use a frac plug and sealing ball. A frac plug is a hollow, cylindrical plug that can be installed in the tubular to selectively isolate portions of the well. The sealing ball is then pumped down the well until it seats on a sealing element in the frac plug.

Seating the ball stops fluid flow through the bore of the frac plug. There is also a seal between the outer diameter of the frac plug and the tubular. Thus, hydrocarbons from the reservoir cannot flow through the bore of the frac plug and cannot divert around the outside of the frac plug. This isolates the selected portions of the well by preventing fluid flow from the surface to the reservoir and vice versa.

Frac plugs are usually built around a central mandrel. Typically, the central mandrel is then positioned in the wellbore and held in place using upper and lower slips. However, the frac plugs can decrease the inner diameter of the tubular where they are installed and may restrict flow after stimulating the reservoir.

Additionally, the sealing element of the frac plug on which the ball seats is positioned between the slips. This arrangement may prevent the sealing element from fully compressing if the slips become fully engaged prior to full compression of the sealing element. This, in turn, allows fluids to leak past the frac plug and defeat the isolation. Further, sometimes a portion of the wellbore is horizontal and it can be difficult to position the sealing ball in the horizontal portion.

What is needed, therefore, is an apparatus that does not significantly decrease the inner diameter of the tubular, ensures that the tubular is sealed for isolation, and includes a bore-sealing element that can be easily positioned within a horizontal tubular section.

### SUMMARY

Embodiments of the disclosure may provide a retainer. The retainer may include an annular body and a slip. The annular body may have a first outer surface and include a first taper that extends along at least a portion of the first outer surface. The slip may be circumferentially disposed about the annular body and have a first axial end, a second axial end, an inner surface, a second outer surface, and an axial length extending between the first axial end and the second axial end. The slip may also include a second taper that extends along the inner surface and engages with the first taper. The slip may further include a left-hand thread pattern defined by the second outer surface that extends from the first axial end along a first portion of the axial length. Each thread the left-hand thread pattern may have a crest that is angled towards the first axial end.

Embodiments of the disclosure may further provide a dart. The dart may include a cap defining a vented cavity, a sealing element, and an engagement member that extends from the sealing element and that is slidably engaged with the cap. The sealing element may include a body that expands radially as it is compressed. The sealing element may further include a plurality of fins extending radially from the body. The plurality of fins may include a first fin that seals against the cap as the body is compressed.

Embodiments of the disclosure may further provide an apparatus for sealing a tubular section. The apparatus may include a retainer and a dart. The retainer may include an annular body and a means for mechanically engaging the tubular section. The dart may include a cap, a sealing element, and an engagement member. The cap may define a vented cavity and seat against the annular body of the retainer when positioned within the tubular section. The sealing element may seal the tubular section as it is compressed against the cap. The engagement member may extend from the sealing element and engage with the cap through the vented cavity.

Embodiments of the disclosure may further provide a retainer. The retainer may include an annular body and a plurality of fasteners. The annular body may define a plurality of holes. The plurality of fasteners may be configured to couple the annular body to a tubular section. Each fastener of the plurality of fasteners may be disposed within a respective hole of the plurality of holes.

Embodiments of the disclosure may further provide a method for sealing a tubular section of a wellbore. The method may include engaging a retainer with the inner diameter of the tubular section without sealing the tubular section. The method may also include pumping a dart including a sealing element down the wellbore to seat at least a portion of the sealing element in a cap and to seat the cap against the retainer. The method may further include compressing the sealing element of the dart against the cap to seal the tubular section.

### BRIEF DESCRIPTION OF THE DRAWINGS

The present disclosure is best understood from the following detailed description when read with the accompanying drawings. It is emphasized that, in accordance with the standard practice in the industry, various features are not drawn to scale. In fact, the dimensions of the various features may be arbitrarily increased or reduced for clarity of discussion.

FIG. 1 illustrates a cross-sectional view of an exemplary tubular sealing apparatus, according to one or more embodiments disclosed.

FIG. 2A illustrates a cross-sectional view of the retainer of FIG. 1.

FIG. 2B illustrates an enlarged view of the portion of the retainer of FIG. 2A indicated by the detail labeled 2B of FIG. 2A.

FIG. 3 illustrates a cross-sectional view of the dart of FIG. 1, according to one or more embodiments disclosed.

FIG. 4 illustrates the retainer of FIG. 1 set within a wellbore.

FIG. 5 illustrates the retainer of FIG. 4 and the dart of FIG. 1 in relation to the retainer.

FIG. 6 illustrates the dart of FIG. 5 compressed against the retainer of FIG. 4.

FIG. 7 illustrates a cross-sectional view of an exemplary tubular sealing apparatus, according to one or more embodiments disclosed.

FIG. 8 illustrates a cross-sectional view of the retainer of FIG. 7.

FIG. 9 illustrates the retainer of FIG. 7 positioned within a wellbore.

FIG. 10 illustrates the retainer of FIG. 9 expanded within the wellbore.

FIG. 11 illustrates the retainer of FIG. 7 fixed to a tubular section within a wellbore.

FIG. 12 illustrates the retainer of FIG. 11 and the dart of FIG. 7.

FIG. 13 illustrates the dart of FIG. 12 compressed against the retainer of FIG. 11.

FIG. 14 illustrates a flow chart of an exemplary method for sealing a tubular section of a wellbore.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the drawings provided herein. This repetition is for the purpose of simplicity and clarity and does not in itself dictate a relationship between the various exemplary embodiments and/or configurations discussed in the various drawings. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

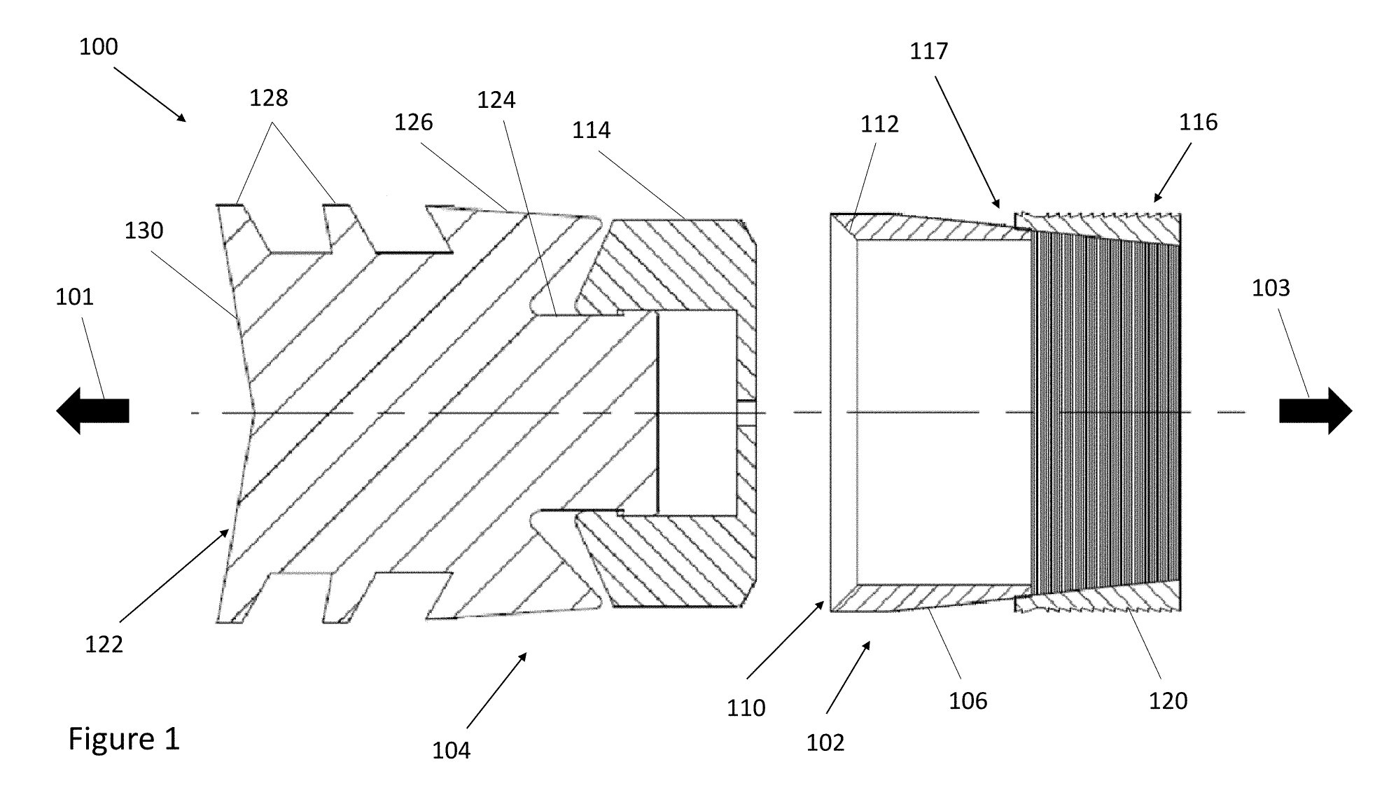

FIG. 1 illustrates an exemplary tubular sealing apparatus 100, according to one or more embodiments disclosed. The uphole and downhole directions of the tubular sealing apparatus 100 are indicated by the arrows 101 and 103, respectively. Those in the art having the benefit of this disclosure will appreciate that these terms are defined relative to the direction of the tubular sealing apparatus 100 when installed in a tubular section (not shown) for the intended use as is customary in the art.

The tubular sealing apparatus 100 may include a retainer 102 and a dart 104. The retainer 102 may include an annular body 106 having an uphole axial end portion 110 that defines a seat 112 for a cap 114 of the dart 104. Other embodiments of the retainer (not shown) may omit the seat 112. The retainer 102 may further include a slip 116 coupled to the downhole side 117 of the annular body 106. As shown in the exemplary embodiment, the slip 116 may define a left-hand thread profile 120.

The dart 104 may include a sealing element 122 coupled to the cap 114 though an engagement member 124, as shown in FIG. 1. A primary fin 126 and a plurality of secondary fins 128 may extend radially outward from a body 130 of the sealing element 122. Additionally, at least one the fins 126, 128 may be angled uphole 101, as shown in the exemplary embodiment. Other embodiments of the dart may include one or more fins (not shown) that are perpendicular to the sealing element 122.

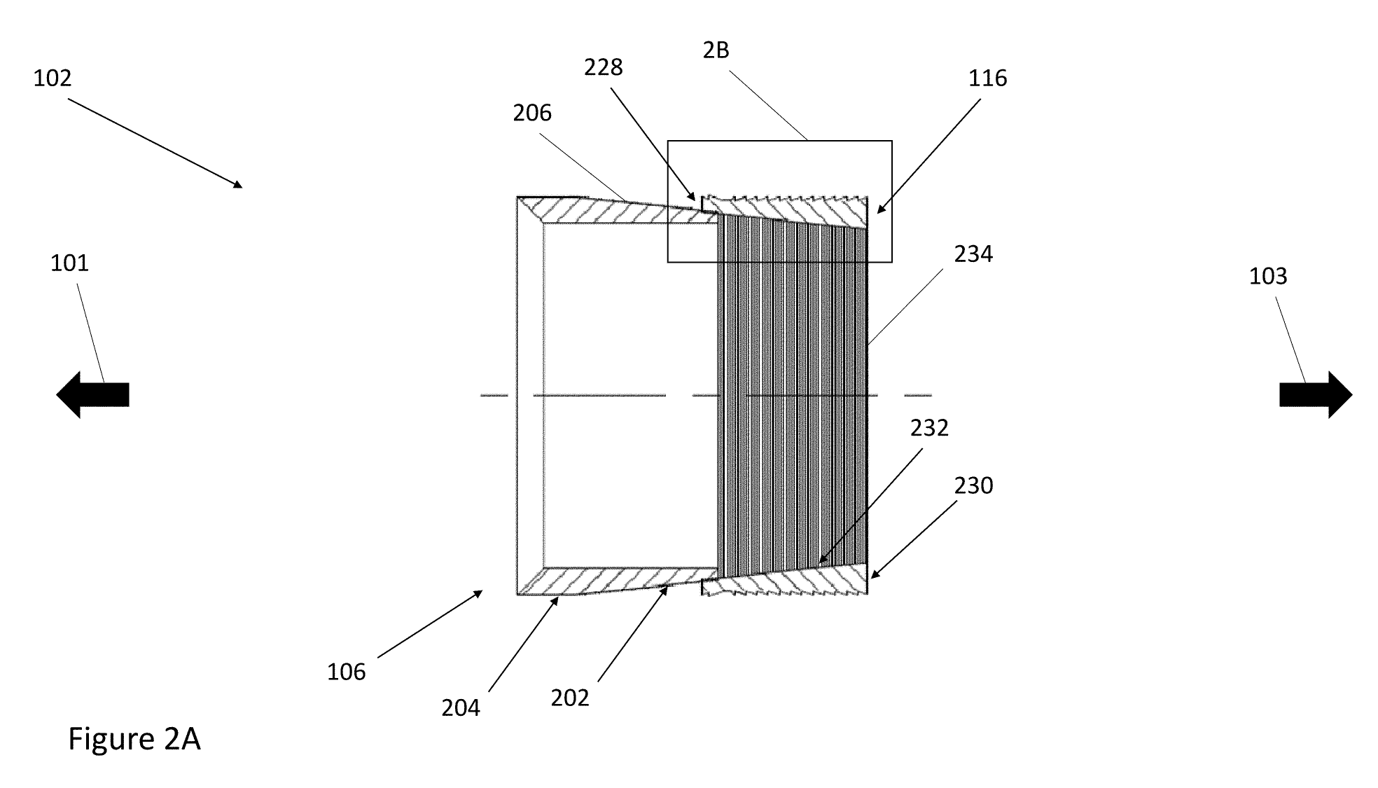

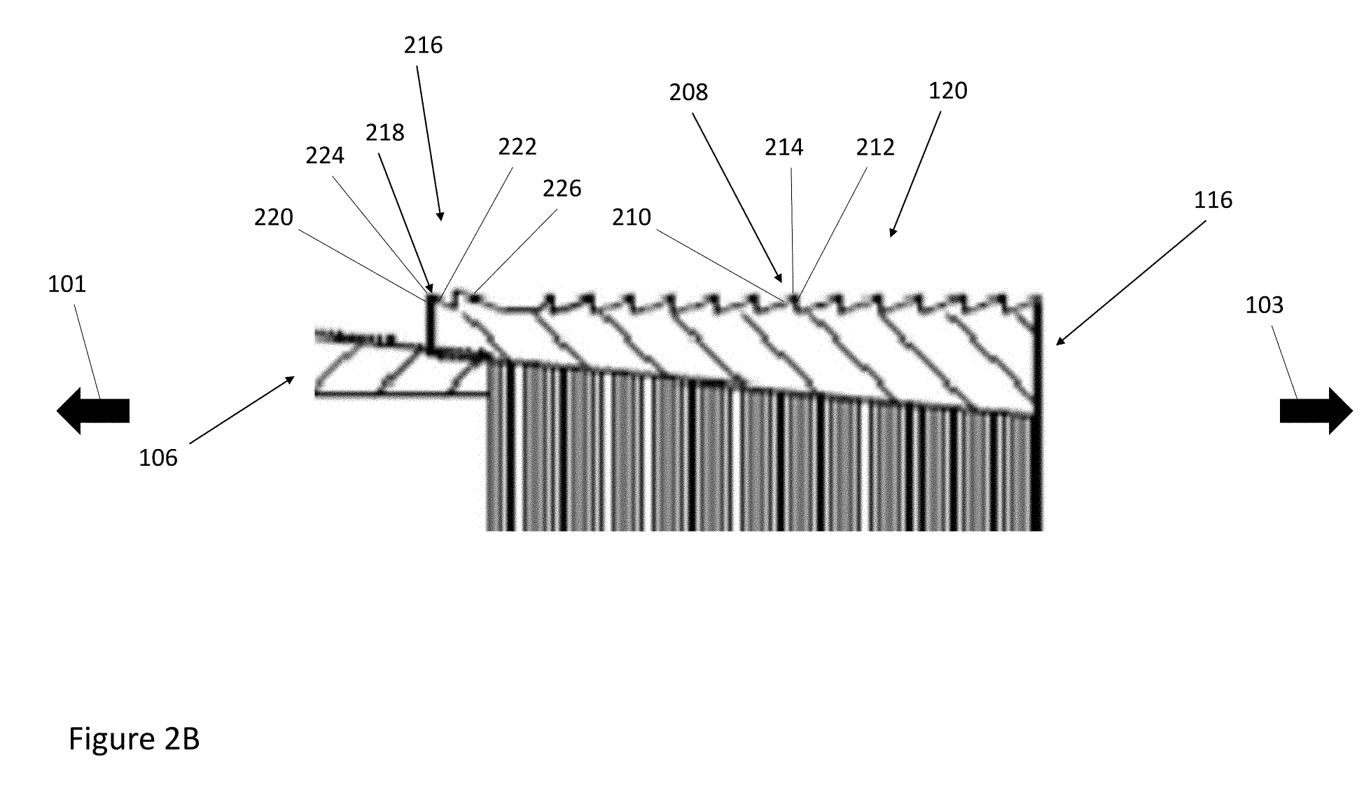

FIG. 2A illustrates the retainer 102 of FIG. 1. In at least one embodiment, the annular body 106 may include a tapered portion 202 extending along at least a portion of the outer surface 204. The annular body 106 may also include serrations 206 defined in the tapered portion 202 of the outer surface 204. Other embodiments of the annular body 106 may replace the serrations 206 with a thread profile (not shown), or the serrations 206 may be omitted.

FIG. 2B illustrates an enlarged view of the portion of the retainer 102 indicated by the detail labeled 2B of FIG. 2A. In the exemplary embodiment, each thread 208 (only one indicated) of the left-hand thread profile 120 may include a first flank 210 that is longer than a second flank 212, angling the crest 214 of each thread 208 downhole 103. As shown in FIG. 2B, a portion 216 of the slip 116 adjacent to the annular body 106 may define one or more threads 218 (only one indicated) having a first flank 220 that is shorter than a second flank 222, angling the crest 224 of each thread 218 uphole 101.

In this particular embodiment of the slip 116, a second thread 226 may have a larger pitch, a larger pitch diameter, or both a larger pitch and a larger pitch diameter than the other threads 218 that have crests 224 angled uphole 101. Other embodiments of the slip 116 may include threads 218 that all have a pitch and a pitch diameter that are the same size, or a different thread (not shown) may have a larger pitch, a larger pitch diameter, or both a larger pitch and a larger pitch diameter than the other threads 218. In another embodiment, the threads 218 may be replaced by teeth (not shown) that have points (not shown) angled uphole 101. Further embodiments of the slip 116 may include a left-hand thread profile 120, threads 218, or both a left-hand thread profile 120 and threads 218 that have crests 214, 224 that are generally perpendicular to the slip 116.

Returning to FIG. 2A, the slip 116 may further include a plurality of longitudinal grooves (not shown). The grooves may extend along a portion of the axial length of the slip 116. In one embodiment, adjacent grooves extend from alternating axial end portions 228, 230 of the slip 116. In another embodiment, the grooves may extend from only one axial end portion 228, 230 of the slip 116. Other embodiments of the slip 116 may include two or more adjacent grooves that extend from the same axial end portion 228, 230 of the slip 116, include grooves that extend axially through the slip 116 without interfacing with either axial end portion 228, 230, or omit the grooves.

An inner surface 232 of the slip 116 may be radially tapered in an outward direction as it moves from the axial end portion 230 toward the axial end portion 228, as shown in the exemplary embodiment. The slip 116 may further include a thread profile 234 defined in the inner surface 232 that engages with the serrations 206 of the annular body 106 to couple the slip 116 to the annular body 106. Other embodiments of the slip 116 may include a plurality of radial grooves (not shown) instead of a thread profile 234.

In the exemplary embodiment, the annular body 106 and the slip 116 are made of a high-yield aluminum. Other embodiments of the annular body 106 and the slip 116 may be made of steel, a high-yield cast metal, a high-yield powdered metal, or a composite material. In at least one embodiment, the annular body 106 and the slip 116 are made of different materials, such as, for example, a high-yield aluminum annular body 106 and a powdered metal slip 116, a steel annular body 106 and a cast metal slip 116, or any other possible combination of annular body 106 material and slip 116 material.

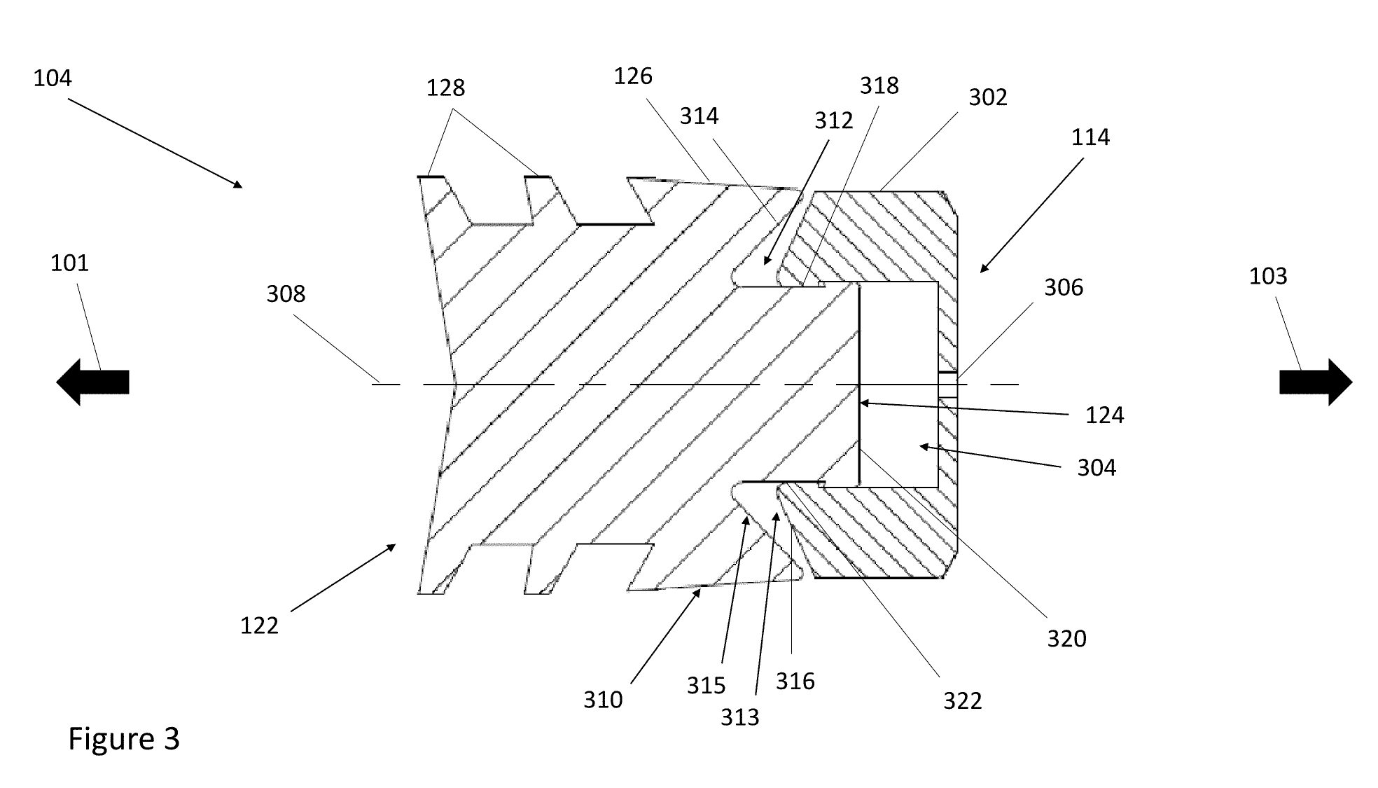

FIG. 3 illustrates the dart 104 of FIG. 1. The cap 114 may be a cylindrical body 302 that defines a cavity 304. The cap 114 may further define a vent 306 for the cavity 304. In another embodiment, the cap 114 may include multiple cavities (not shown) and multiple vents (not shown), each vent extending through the cap 114 into a respective cavity. Other embodiments of the cap 114 may include a vent (not shown) extending radially through the cap 114 to reach the cavity 304, or a vent (not shown) that extends into the cavity 304 at an angle relative to a longitudinal centerline 308.

With reference to the sealing element 122, the primary fin 126 may be wider than the secondary fins 128. The primary fin 126 may include a tapered outer surface 310 and define a recess 312 that is adjacent to the cap 114, as shown in the exemplary embodiment. Other embodiments of the primary fin 126 may omit the taper 310, the recess 312, or both. Although the exemplary embodiment includes two secondary fins 128, other embodiments of the sealing element 122 may include one, three, or more secondary fins 128.

The sealing element 122 is configured to compress against an uphole end 313 of the cap 114. The recess 312 and a tapered inner surface 314 of the primary fin 126 mirror a tapered surface 316 on the uphole end 313 of the cap 114. Thus, and more particularly, the downhole end 315 of the primary fin 126 mirrors in structure the uphole end 313 of the cap 114 such that, under pressure as described below, the primary fin 126 will compress against the tapered surface 316 of the cap 114.

The engagement member 124 may extend from the sealing element 122 and engage the sealing element 122 with the cap 114 as shown in FIG. 3. The engagement member 124 may include a neck 318 that extends into the cavity 304 of the cap 114. The neck 318 may include a flange 320 that is retained within the cavity 304 by a lip 322 extending from the cap 114. Other embodiments of the dart 104 may include multiple engagement members (not shown) that engage with respective vented cavities (not shown) defined by the cap 114.

In the exemplary embodiment, the sealing element 122 and the cap 114 are made of a dissolvable rubber. Other embodiments of the sealing element 122, the cap 114, or both may be made of another dissolvable material know in the industry. Further embodiments of the sealing element 122 and the cap 114 may use different types of dissolvable rubber. In at least one embodiment, the sealing element 122, the cap 114, or both are made from a material that is not dissolvable.

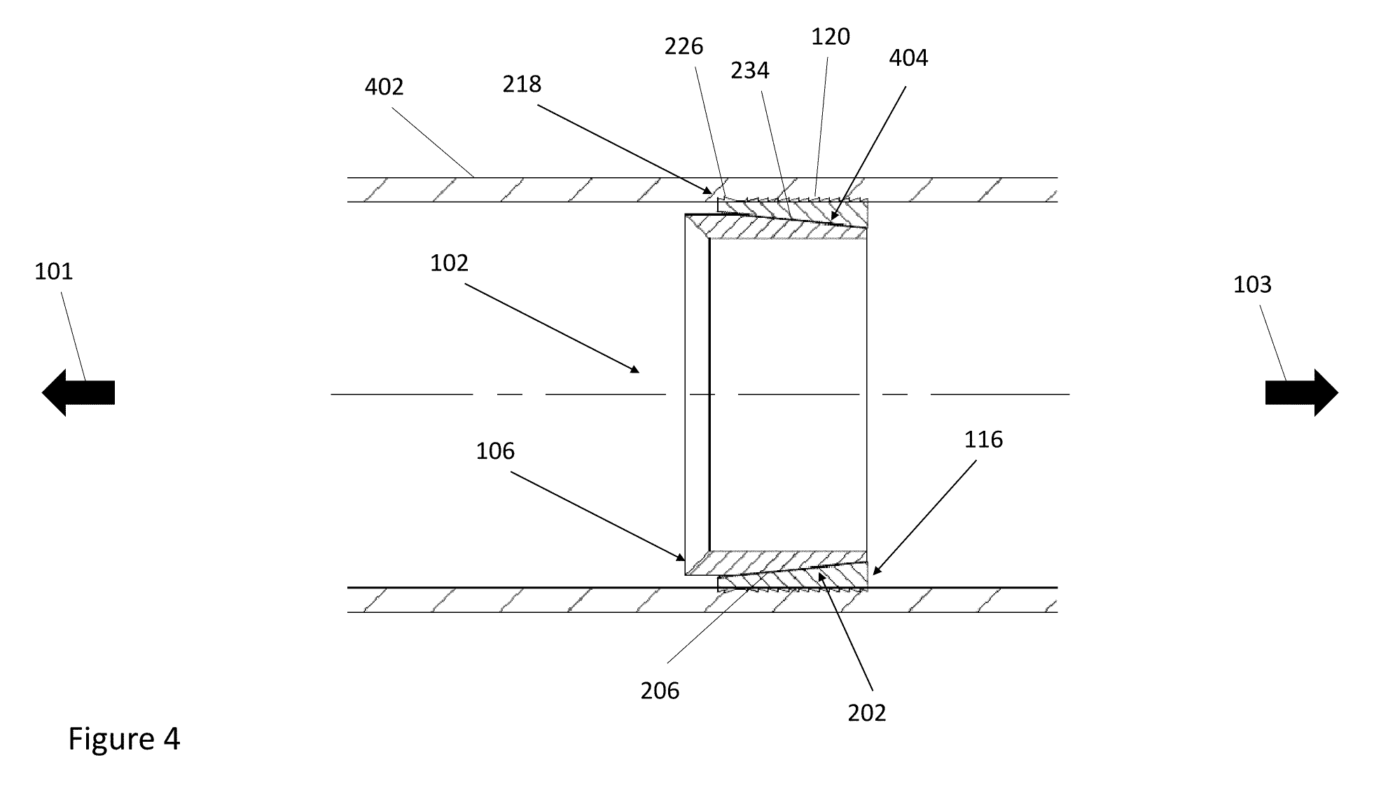

FIGS. 4-6 illustrate the installation of the tubular sealing apparatus 100 of FIG. 1 within a tubular section 402. The tubular section 402 is, in the illustrated embodiment, a section of the casing, but may be any type of tubular that is set in a wellbore, as known to the art. The retainer 102 is positioned within the tubular section 402 by a running tool (not shown) that extends through the retainer 102. The retainer 102 is held on the running tool by a shear ring (not shown) configured to break at a predetermined load and a cylindrical retainer (not shown). The shear ring may be positioned adjacent to the slip 116 and the cylindrical retainer may be positioned adjacent to the annular body 106.

Once the retainer 102 reaches the desired location, the running tool begins to compress the retainer 102 by pulling the slip 116 towards the annular body 106, and pushing the annular body 106 towards the slip 116. The slip 116 expands as it travels uphole 101 over the tapered portion 202 of the annular body 106. In some embodiments, this expansion may cause the slip 116 to fracture along grooves (not shown), creating a plurality of slip segments (not shown). In other embodiments, grooves in the slip 116 may allow the slip 116 to expand without fracturing. Another embodiment of the slip 116 may expand along the tapered portion 202 of the annular body 106 without the use of grooves.

As the retainer 102 is set, the threads 218 having crests 224 that are angled uphole 101, shown in FIG. 2B, contact the tubular section 402, as show in FIG. 4. The threads 218, and, in particular, the larger thread 226, may engage or “bite into” the inner diameter of tubular section 402, preventing further movement of the slip 116 towards the annular body 106. Since the retainer 102 is being compressed by the running tool, the running tool will continue to push the annular body 106 towards the slip 116. This movement further expands the slip 116 along the tapered portion 202 of the annular body 106. The continued expansion of the slip 116 allows the left-hand thread profile 120 of the slip 116 to engage with the tubular section 402, preventing movement of the slip 116 away from the annular body 106 and further holding the retainer 102 in position.

The interface 404 between the serrations 206 of the annular body 106 and the thread profile 234 of the slip 116 may also have a ratcheting effect. The ratcheting effect allows the thread profile 234 of the slip 116 to slide over the serrations 206 of the annular body 106 in one direction, but restricts movement of the serrations 206 in the opposite direction. Accordingly, the ratcheting effect may prevent movement of the annular body 106 away from the slip 116.

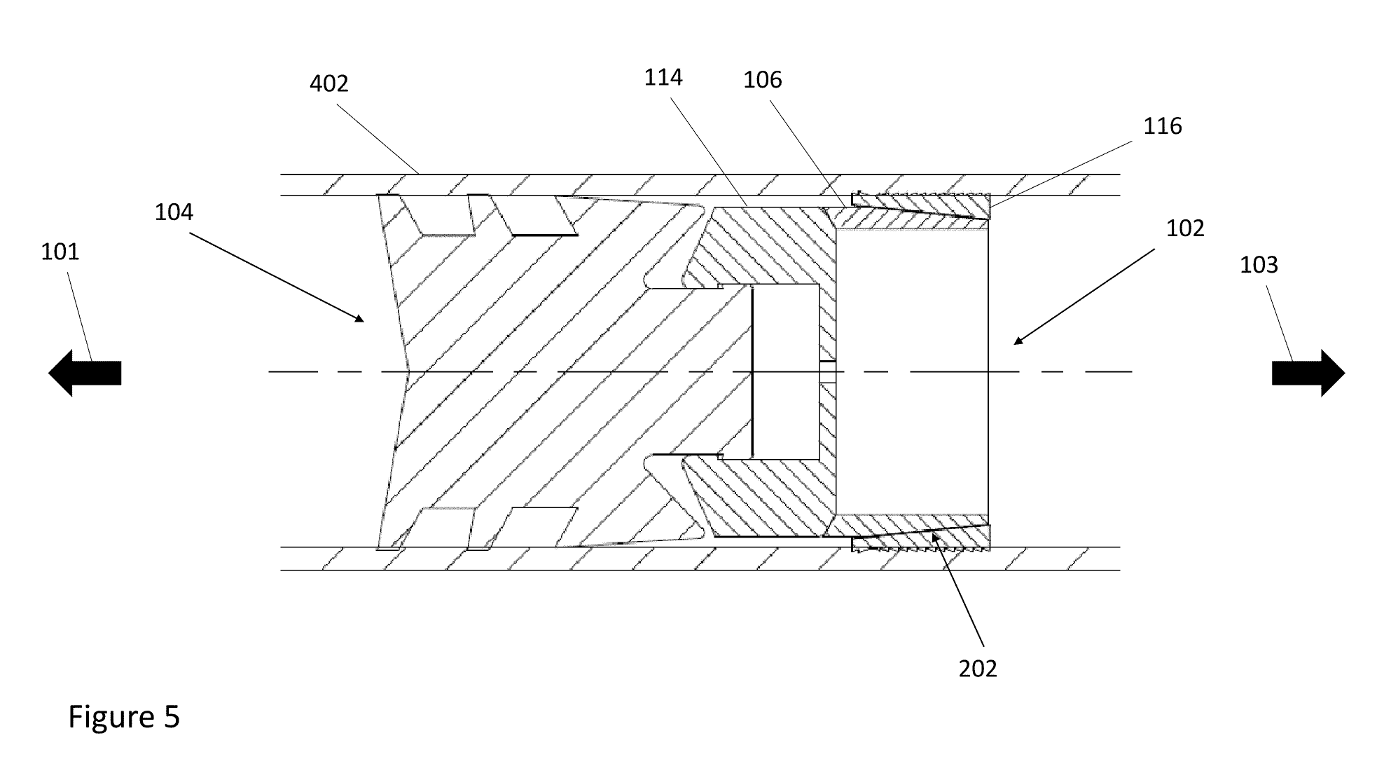

Once the retainer 102 has been set within the tubular section 402, a dart 104 may be pumped down the tubular section 402. As shown in FIG. 5, the cap 114 of the dart 104 may contact the annular body 106 of the retainer 102, preventing further downhole 103 movement of the dart 104. The force of the cap 114 against the annular body 106 of the retainer 102 may further secure the retainer 102 in place by shifting the slip 116 further along the tapered portion 202 of the annular body 106.

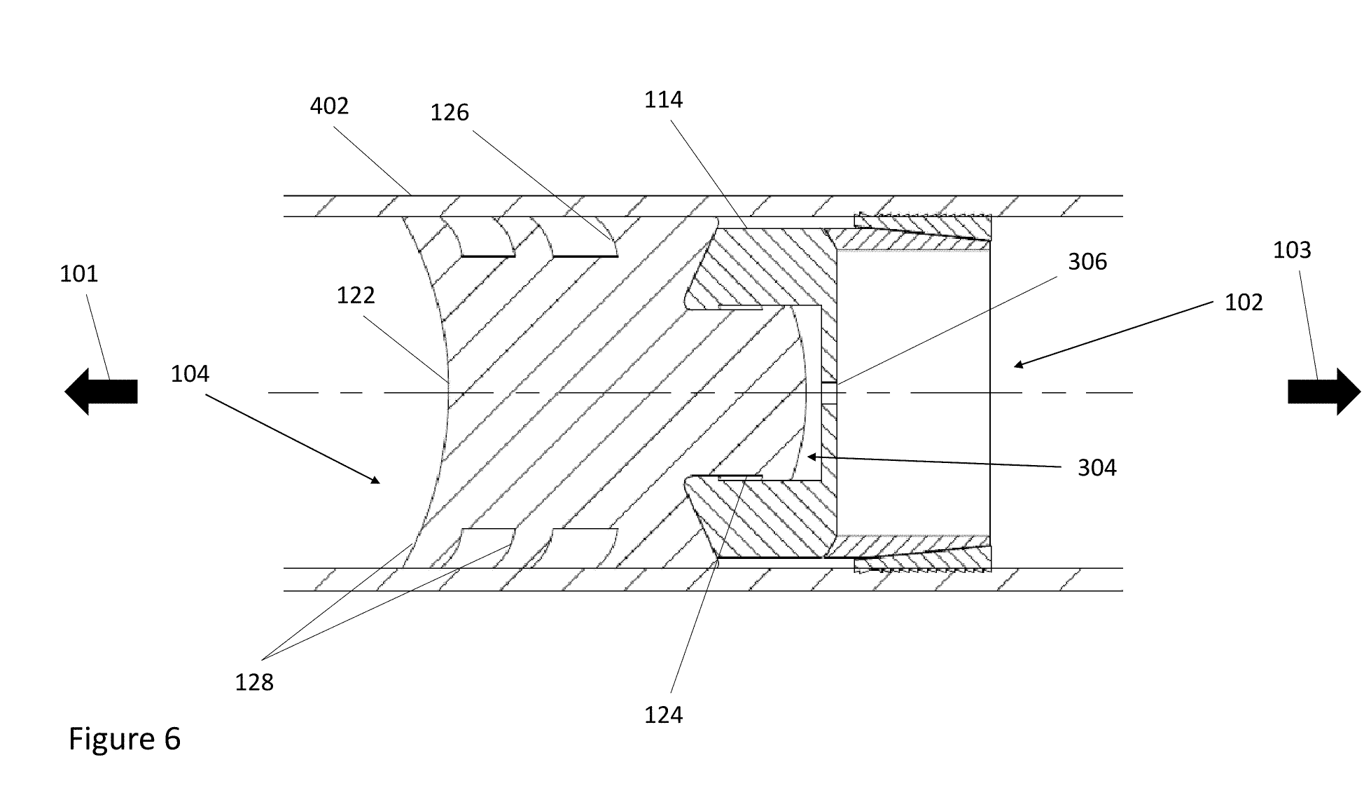

After the dart 104 contacts the retainer 102, pressure uphole 101 of the dart 104 compresses the sealing element 122 against the cap 114, as shown in FIG. 6. The vent 306 prevents pressure from building within the cavity 304 of the cap 114, allowing the engagement member 124 to shift within the cavity 304. This movement presses the primary fin 126 against the cap 114 to seal the tubular section 402. The secondary fins 128 are also forced against the tubular section 402 by an outer diameter slightly larger than the inner diameter of the tubular section 402, creating additional seals within the tubular section.

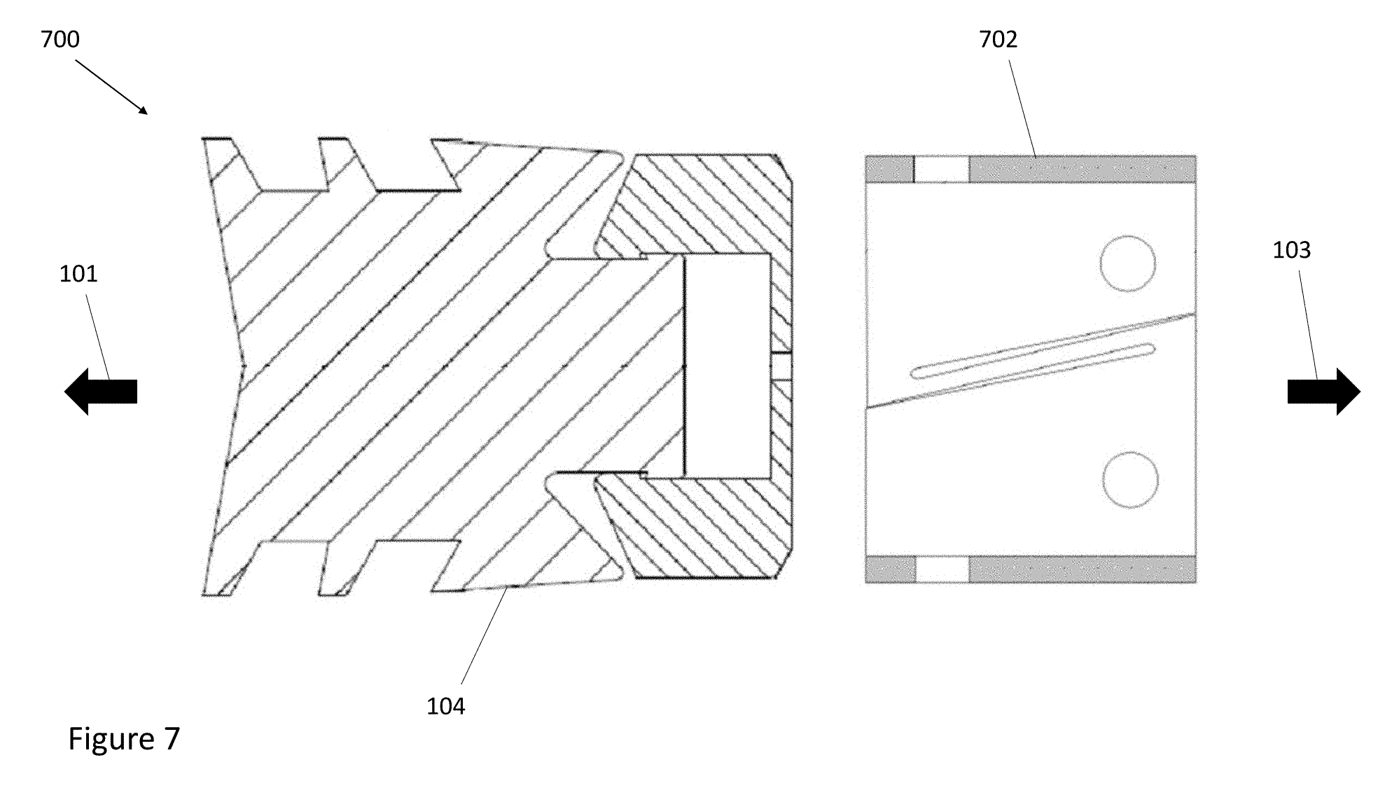

FIG. 7 illustrates a cross-sectional view of an exemplary tubular sealing apparatus 700, according to one or more embodiments. The tubular sealing apparatus 700 illustrated in FIG. 7 may include a retainer 702 and the dart 104 describe above with respect to the tubular sealing apparatus 100 and shown in FIGS. 1, 3, 5, and 6. Accordingly, the tubular sealing apparatus 700 may be best understood with reference to the tubular sealing apparatus 100, where like numerals indicate like elements and therefore will not be described again in detail.

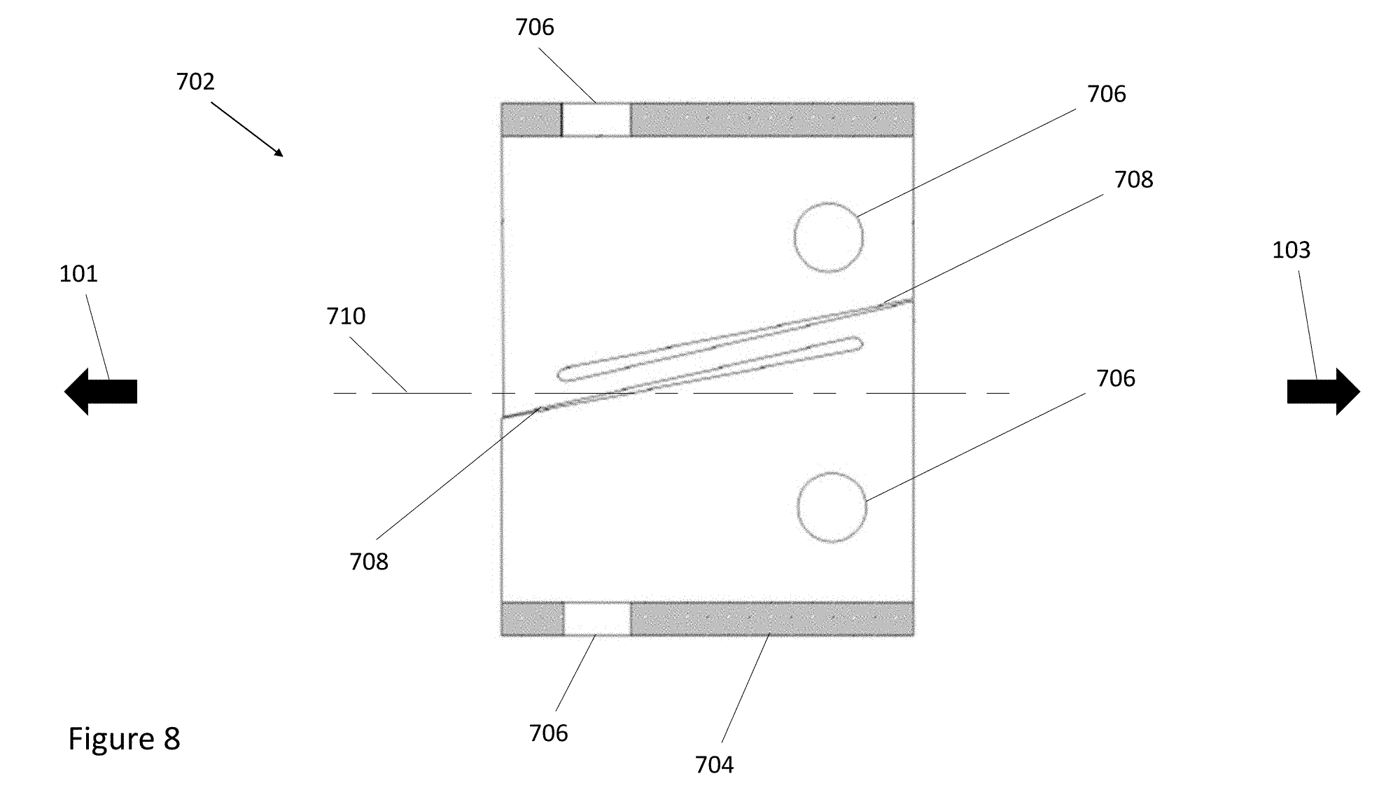

The retainer 702 may be made of a high-yield aluminum. Other embodiments of the retainer 702 may be made of steel, a high-yield cast metal, a high-yield powdered metal, or a composite material. As shown in FIG. 8, the retainer 702 may include an annular body 704. The annular body 704 may define a plurality of holes 706 that extend through the thickness of the annular body 704. In the exemplary embodiment, the holes 706 are unthreaded and similar in size. Other embodiments may include threaded holes (not shown), holes (not shown) that are different sizes, or any combination thereof. Further embodiments of the retainer 702 may include holes (not shown) that extend only partially through the annular body 704 or omit the holes 706.

The annular body 704 may also include a plurality of grooves 708 extending along a portion of an axial length of the annular body 704. The grooves 708 may be angled with respect to a center axis 710, as shown in FIG. 8. Other embodiments may include grooves 708 that are parallel to the center axis 710. In at least one embodiment, the grooves 708 may be omitted and the retainer 702 may include a plurality of separate arcuate sections (not shown) that each define a plurality of holes 706.

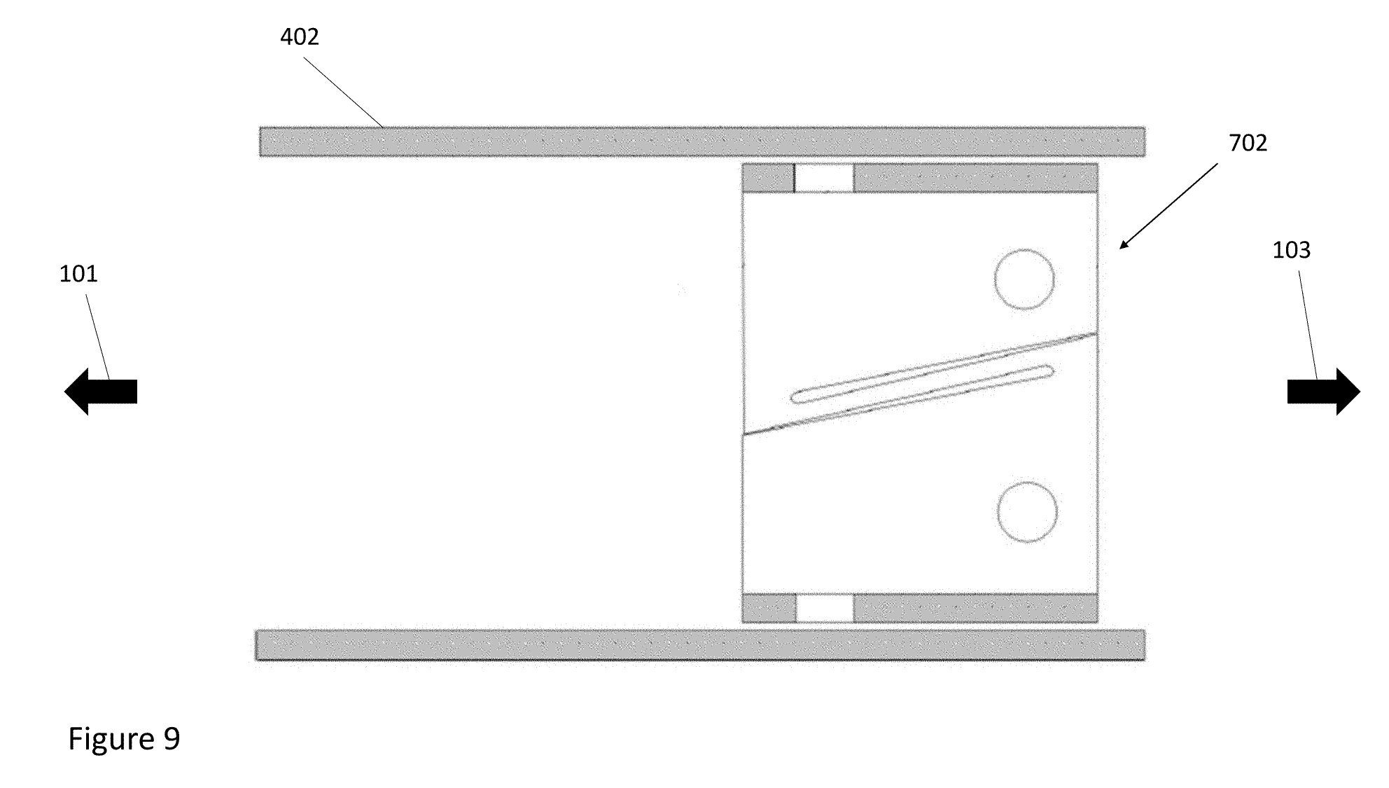

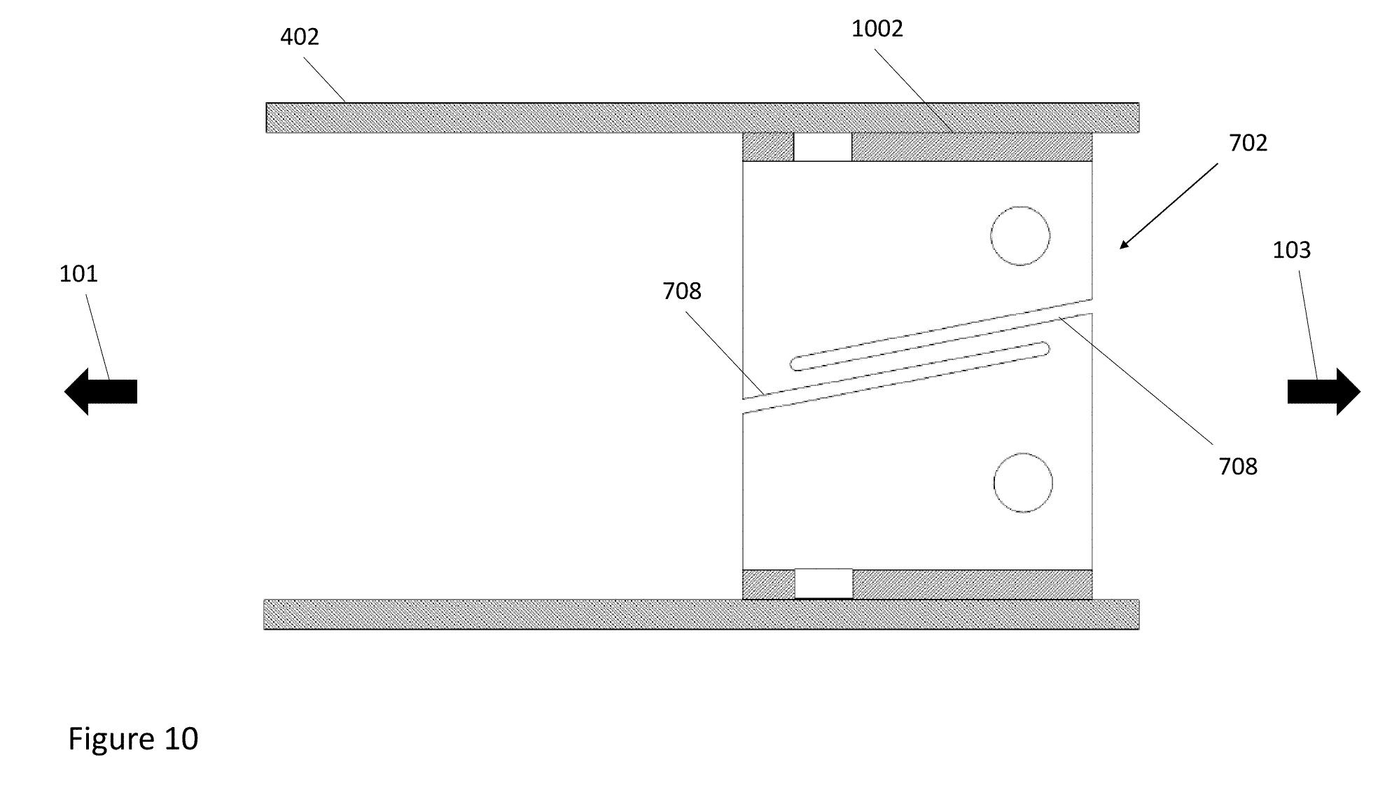

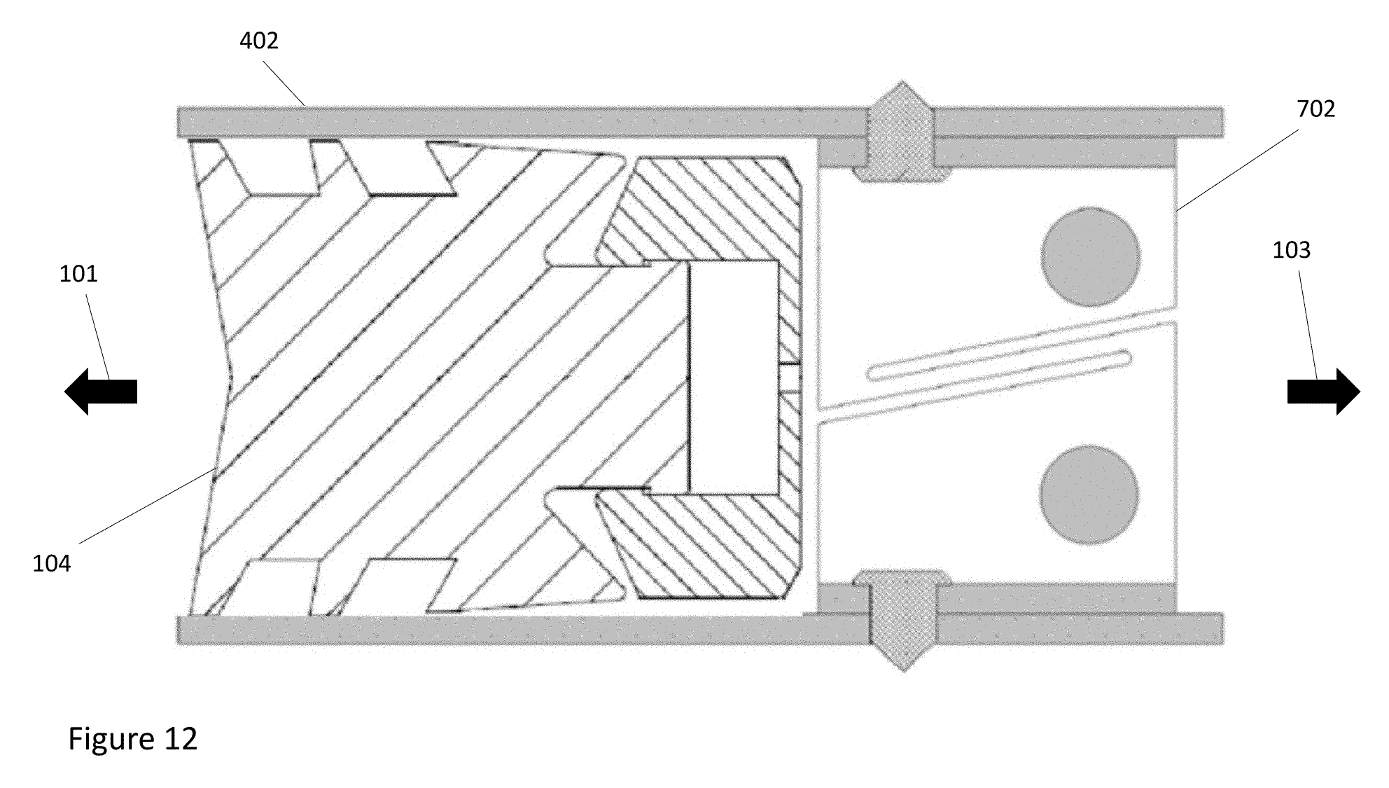

FIGS. 9-13 illustrate the installation of the tubular sealing apparatus 700 of FIG. 7. The retainer 702 is positioned within the tubular section 402 by a running tool (not shown) that extends into the retainer 702. Once the retainer 702 reaches the desired location, the running tool expands the retainer 702, causing the outer surface 1002 of the retainer 702 to contact the tubular section 402 as shown in FIG. 10. The grooves 708 in the retainer 702 may allow the retainer 702 to expand without fracturing. Other embodiments of the retainer 702 may fracture along the grooves 708 when expanded, forming multiple arcuate segments (not shown), or the running tool may position a retainer 702 made up of a plurality of separate arcuate segments (not shown) against the tubular section 402.

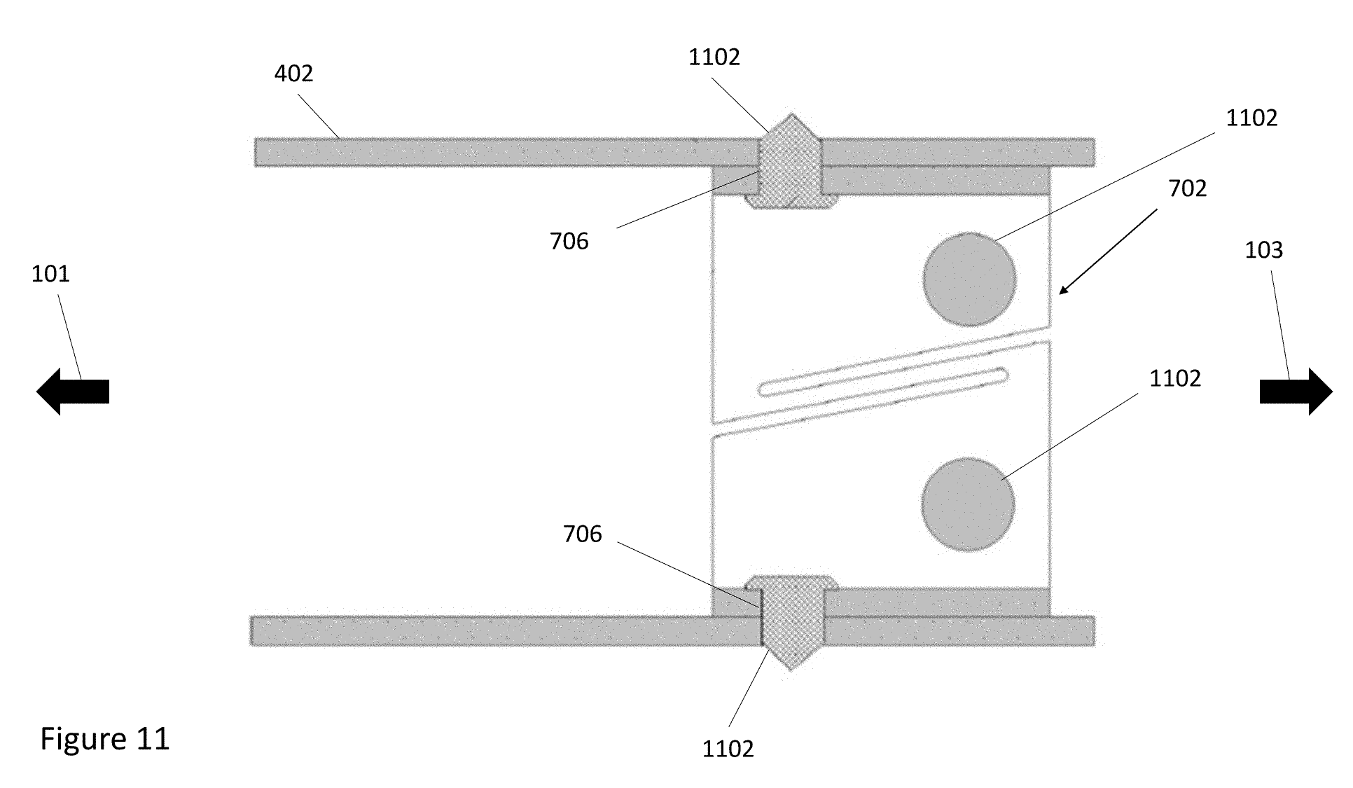

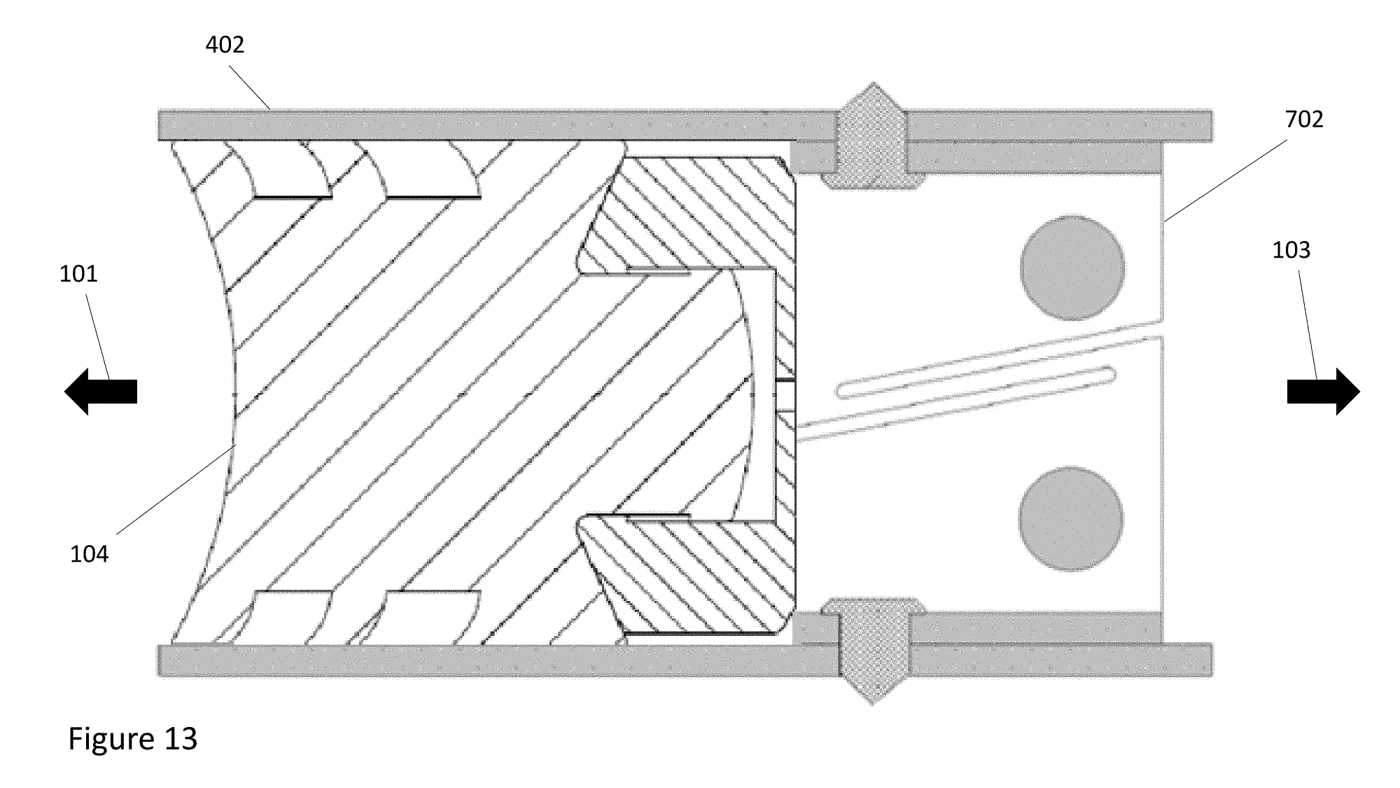

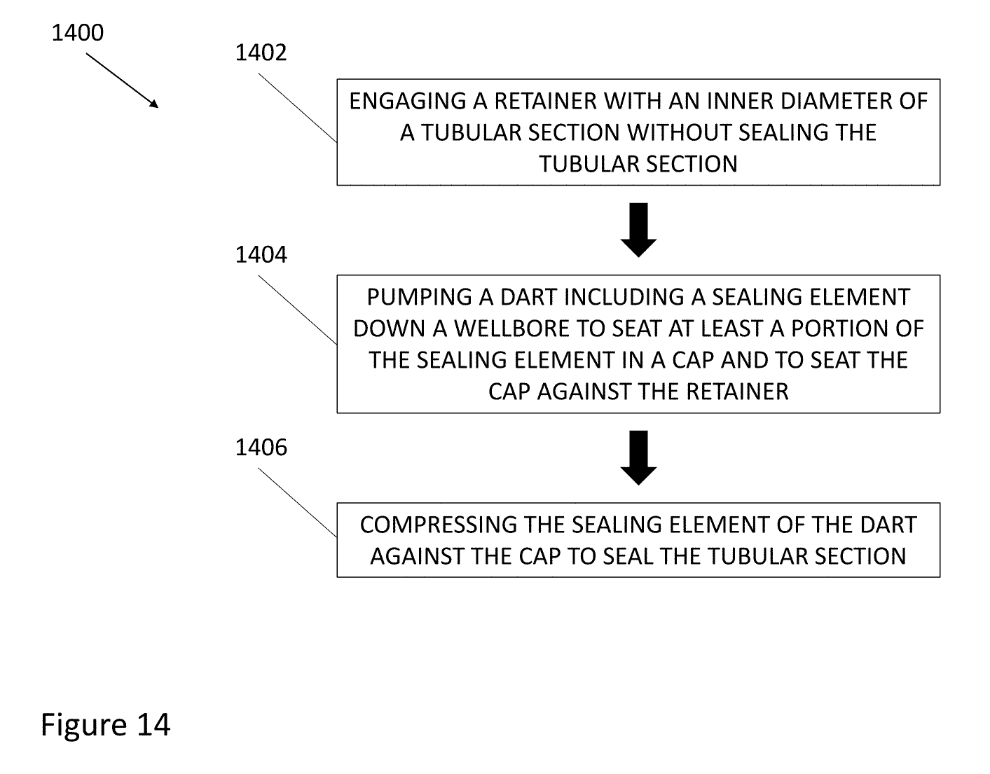

After expanding or otherwise positioning the retainer 702 against the tubular section 402, the running tool installs a plurality of fasteners 1102 that couple the retainer 702 to the tubular section 402 and hold the retainer 702 in position within the tubular section 402. As shown in FIG. 11, the fasteners 1102 may extend through the plurality of holes 706 defined by the annular body 704 of the retainer 702. In the exemplary embodiment, the fasteners 1102 are bolts that are fired through the tubular section 402. Other embodiments of the retainer 702 may include screws (not shown) that extend into or through the tubular section 402, or pins (not shown) that utilize an interference fit to secure the retainer 702 in position within the tubular section 402. After setting the retainer 702, the running tool is withdrawn from the wellbore and the dart 104 may be pumped down to seal the tubular section 402 as describe above and shown in FIGS. 13 and 14.

In light of the foregoing disclosure, FIG. 14 illustrates a flow chart 1400 of an exemplary method for sealing a tubular section 402 of a wellbore. The method may include engaging a retainer 102, 702 with an inner diameter of a tubular section 402 without sealing the tubular section 402, as shown at 1402. The method may also include pumping a dart 104 including a sealing element 122 down a wellbore to seat at least a portion of the sealing element 122 in a cap 114 and seat the cap 114 against the retainer 102, 702, as shown at 1404. The method may further include compressing the sealing element 122 of the dart 104 against the cap 114 to seal the tubular section 402, as shown at 1406.

In addition to the embodiments described above, U.S. Provisional Patent Application Ser. Nos. 62/349,177, and 62/397,041 incorporated by reference above disclose additional embodiments differing from embodiments described herein in various ways. Although not expressly disclosed herein, these embodiments disclosed in the aforementioned provisional applications are, as previously stated, incorporated by reference into the present application to the extent consistent with the present application. It is to be understood that the lack of an express disclosure herein does not disclaim such embodiments. Those incorporated embodiments are, through their incorporation, a part of this disclosure as if expressly set forth herein. They, therefore, are within the scope of the subject matter claimed below.

As previously noted, the embodiments disclosed in the above provisional applications differ from the embodiments disclosed herein. For example, one embodiment disclosed in Provisional Applications 62/349,177 and 62/397,041 includes a plurality of arcuate segments (not shown) that are coupled to the tubular section 402 through welding, bolting, or other similar means. Two such means are illustrated herein and discussed above-namely, a threaded engagement of a slip and bolting. However, these are, by way of example and illustration, but two means by which this may be achieved. Still other means performing this function through equivalent structure and use may become apparent to those skilled in the art having the benefit of this disclosure. Any such means may be used in various embodiments.

An additional embodiment of the retainer (not shown) disclosed in Provisional application Provisional Applications 62/349,177 and 62/397,041 includes a single rectangular body (not shown) that may be retained within the tubular section 402 using an interference fit. Provisional application Provisional Applications 62/349,177 and 62/397,041 further disclose a sealing dart (not shown) that includes a plurality of annular seals (not shown) coupled to a dart body (not shown).

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A retainer, comprising:
an annular body having a first outer surface and including a first taper that extends along at least a first portion of the first outer surface; and
a slip circumferentially disposed about the first taper of the annular body, the slip having a first axial end, a second axial end, an inner surface, a second outer surface, and an axial length extending between the first axial end and the second axial end, and including:
a second taper that extends along the inner surface and engages the first taper, and
a left-hand thread pattern defined by the second outer surface and extending from the first axial end along a first portion of the axial length, each thread of the left hand thread pattern having a crest that is angled towards the first axial end.

2. The retainer of claim 1, wherein the slip further comprises at least one thread defined by the second outer surface and adjacent the second axial end, the at least one thread having a crest that is angled away from the left-hand thread pattern.

3. The retainer of claim 1, wherein the slip defines a plurality of grooves, the plurality of grooves circumferentially spaced about a longitudinal axis of the slip and extending along a second portion of the axial length.

4. The retainer of claim 3, wherein adjacent grooves of the plurality of grooves alternately extend from the first axial end and the second axial end.

5. The retainer of claim 1, wherein the annular body comprises a metal, a powdered metal, or a composite.

6. The retainer of claim 1, wherein the inner surface of the slip is threadably engaged with the first outer surface.

7. A dart, comprising:
a cap defining a vented cavity; and
a sealing element, including:
a body that expands radially as it is compressed, and
a plurality of fins extending radially from the body, the plurality of fins including a first fin that seals against the cap as the body is compressed; and
an engagement member extending from the sealing element, the engagement member being slidably engaged with the cap.

8. The dart of claim 7, wherein the sealing element comprises a dissolvable material.

9. The dart of claim 7, wherein the cap comprises a dissolvable material.

10. An apparatus for sealing a tubular section, comprising:
a retainer, including:
an annular body, and
a means for mechanically engaging the tubular section; and
a dart, including:
a cap defining a vented cavity that seats against the annular body of the retainer,
a sealing element that seals the tubular section as it is compressed against the cap, and
an engagement member extending from the sealing element, the engagement member engaging the cap through the vented cavity.

11. The apparatus of claim 10, wherein the annular body defines a plurality of holes and wherein the means for mechanically engaging the tubular section comprises a plurality of fasteners configured to couple the annular body to the tubular section, each fastener disposed within a respective hole of the plurality of holes.

12. The apparatus of claim 11, wherein the annular body further defines a plurality of grooves, each groove extending along a portion of an axial length of the annular body.

13. The apparatus of claim 10, wherein the means for mechanically engaging the tubular section comprises a slip circumferentially disposed about the annular body.

14. The apparatus of claim 13, wherein the slip has a first axial end, a second axial end, an inner surface, an outer surface, and an axial length extending between the first axial end and the second axial end, and comprises:
a second taper that extends along the inner surface and engages the first taper, and
a left-hand thread pattern defined by the outer surface and extending from the first axial end along a first portion of the axial length, each thread of the left hand thread pattern having a crest that is angled towards the first axial end.

15. The apparatus of claim 14, wherein the slip further comprises at least one thread defined by the outer surface and adjacent the second axial end, the at least one thread having a crest that is angled away from the left-hand thread pattern.

16. The apparatus of claim 14, wherein the slip defines a plurality of grooves, the plurality of grooves circumferentially spaced about a longitudinal axis of the slip and extending along a second portion of the axial length.

17. The apparatus of claim 13, wherein an inner surface of the slip is threadably engaged with an outer surface of the annular body.

18. The apparatus of claim 10, wherein the cap comprises a dissolvable material.

19. The apparatus of claim 10, wherein the sealing element comprises a dissolvable material.

20. The apparatus of claim 10, wherein the engagement member comprises a dissolvable material.

21. The apparatus of claim 10, wherein the engagement member comprises a neck that slidably engages with the vented cavity of the cap.

22. The apparatus of claim 10, wherein a plurality of fins extend radially from a body of the sealing element, the plurality of fins including a first fin that seals against the cap as the sealing element is compressed.

23. A retainer, comprising:
an annular body defining a plurality of holes; and
a plurality of fasteners configured to couple the annular body to a tubular section, each fastener of the plurality of fasteners disposed within a respective hole of the plurality of holes.

24. The retainer of claim 23, wherein the annular body further defines a plurality of grooves, each groove extending along a portion of an axial length of the annular body.

25. The retainer of claim 23, wherein the plurality of fasteners are bolts.

26. The retainer of claim 23, wherein the annular body comprises a metal, a powdered metal, or a composite.

27. A method for sealing a tubular section of a wellbore, comprising:
engaging a retainer with an inner diameter of the tubular section without sealing the tubular section;
pumping a dart including a sealing element down the wellbore to seat at least a portion of the sealing element in a cap and to seat the cap against the retainer; and
compressing the sealing element of the dart against the cap to seal the tubular section.

28. The method of claim 27, wherein engaging the retainer with the inner diameter of the tubular section comprises:
compressing the retainer such that a slip of the retainer ratchets along a threadable engagement with an annular body of the retainer,
holding the retainer in a compressed position,
expanding the slip along a tapered portion of an outer surface of the annular body, engaging the slip with the inner diameter of the tubular section, and
holding the retainer in position within the tubular section.

29. The method of claim 27, wherein pumping the dart including the sealing element down the wellbore to seat the at least a portion of the sealing element in the cap and to seat the cap against the retainer comprises engaging an engagement member extending from the sealing element with a vented cavity defined by the cap.

30. The method of claim 27, wherein engaging the retainer with the inner diameter of the tubular section comprises:
expanding the retainer such that an outer surface of the retainer contacts the tubular section; and
coupling the retainer to the tubular section through the use of a plurality of mechanical fasteners that each extend through a respective hole of a plurality of holes defined by the retainer.
